(19) United States
(12) Patent Application Publication
(10) Pub. No.: US 2016/0071128 A1
(43) Pub. Date: Mar. 10, 2016

(54) TAGGANT BASED ON-PRODUCT SURVEYS

(71) Applicant: EMPIRE TECHNOLOGY DEVELOPMENT LLC, Wilmington, DE (US)

(72) Inventor: Ezekiel Kruglick, Poway, CA (US)

(73) Assignee: EMPIRE TECHNOLOGY DEVELOPMENT LLC, Wilmington, DE (US)

(21) Appl. No.: 14/783,472

(22) PCT Filed: May 30, 2013
(86) PCT No.: PCT/US13/43406

§ 371 Date: Oct. 9, 2015

(51) Int. Cl. G06Q 30/02

(52) U.S. Cl. CPC G06Q 30/0203

(57) ABSTRACT

Technologies are generally described for gathering survey response data from consumers by recovering taggants at disposal. Taggants may be incorporated into an on-product survey response label or into a portion of an item by a manufacturer. Prior to disposal, a consumer may remove one or more taggant incorporated survey response labels to indicate a survey response selection. Removal of the labels may also remove the associated taggants. Upon arrival at a disposal entity, the remaining taggants may be separated from the survey response label or item, machine-read, and/or quantified to generate survey response data. The quantified data may then be sent to another entity, such as the manufacturer, a seller, a marketing company, or similar entity.

### BACKGROUND

Unless otherwise indicated herein, the materials described in this section are not prior art to the claims in this application and are not admitted to be prior art by inclusion in this section.

Survey companies, retailers, and manufacturers may spend considerable resources each year on consumer surveys in order to understand consumer choices and what reasons they may have to buy particular products. Using current on-product survey methods, the companies may try to get consumers to respond through mail and/or website portals, but may have limited and/or delayed feedback along with higher costs to implement a custom infrastructure.

Mail or phone surveys may not provide accurate results and can be costly too. Survey companies or manufacturers need to determine contact information for consumers or determine target groups through other means. Even then, successful response collection rates tend to be low because advertising-weary consumers may not respond to incentives in the mail or hang up on survey callers.

### SUMMARY

The present disclosure generally describes techniques for gathering survey response data from consumers by recovering taggants at disposal.

According to some examples, a method is provided for survey response collection from consumers based on recoverable taggants at disposal. The method may include providing a taggant incorporated survey response label attached to an item. The method may also include providing instructions to consumers to indicate a survey response by removing one or more labels from the item such that survey response data is collected through remaining taggants on the item at disposal.

According to other examples, a method is provided for gathering survey response data from consumers by recovering taggants at disposal. The method may include receiving an item with one or more taggant incorporated survey response labels at a disposal entity and separating taggants from the item. The method may also include retrieving survey response data from the separated taggants through a machine-readable process and quantifying the retrieved survey response data.

According to further examples, a system is described for gathering survey response data from consumers by recovering taggants at disposal. The system may include at least one separation module configured to separate taggants from an item with one or more taggant incorporated survey response labels. The system may also include at least one taggant reading module configured to retrieve survey response data from the separated taggants through a machine-readable process and at least one taggant processing module configured to quantify the retrieved survey response data. The system may further include at least one controller configured to coordinate operations of the separation module, the taggant reading module, and the taggant processing module.

According to yet further examples, a taggant-based survey response collection system is described. The system may include one or more survey response labels attached to an item, the labels configured to provide instructions to consumers to indicate a survey response by removing one or more of the labels from the item. The system may also include one or more taggants incorporated into the labels such that survey response data is collected at disposal through taggants remaining on the item after removal of the one or more labels.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system, where a taggant incorporated survey response label or item may be used to gather consumer survey responses associated with the item;

FIG. 2 illustrates an example of survey-directed on-product labeling, where all taggant incorporated labels may be removed by a consumer except for the label indicating a survey response selection;

FIGS. 3A and 3B illustrate another example of survey-directed on-product labeling, where a taggant incorporated label on an item may be removed by the consumer to indicate a survey response selection;

FIG. 4A illustrates an example system, where taggants may be separated, read, and processed at disposal to quantify consumer survey responses and provide them to other entities;

FIG. 4B further illustrates an example system, where taggants may be separated, read, and processed at disposal;

FIG. 5 illustrates a general purpose computing device, which may be used for gathering survey response data from consumers using recovered taggants at disposal;

FIG. 6 is a flow diagram illustrating an example method for gathering survey response data from consumers based on recoverable taggants at disposal that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, apparatus, systems, devices, and/or computer program products related to gathering consumer survey response data by recovering taggants at disposal.

Briefly stated, technologies are generally described for gathering survey response data from consumers by recovering taggants at disposal. Taggants may be incorporated into an on-product survey response label or into a portion of an item by a manufacturer. Prior to disposal, a consumer may remove one or more taggant incorporated survey response labels to indicate a survey response selection. Removal of the labels may also remove the associated taggants. Upon arrival at a disposal entity, the remaining taggants may be separated from the survey response label or item, machine-read, and/or quantified to generate survey response data. The quantified data may then be sent to another entity, such as the manufacturer, a seller, a marketing company, or similar entity.

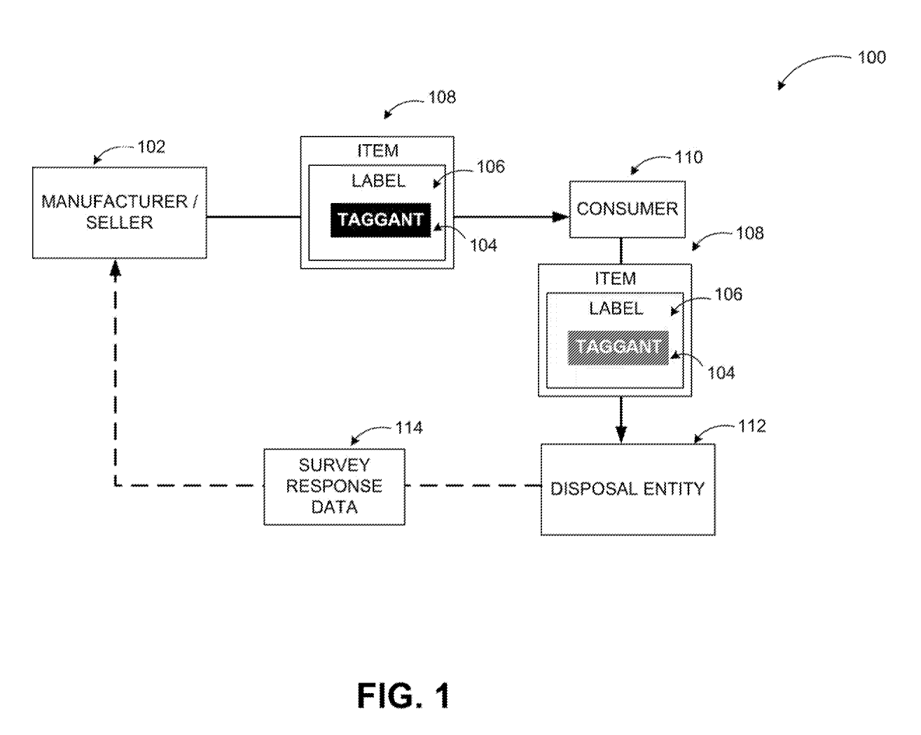

FIG. 1 illustrates an example system, where a taggant incorporated survey response label or item may be used to gather consumer survey responses associated with the item, arranged in accordance with at least some embodiments described herein.

As shown in a diagram 100, a manufacturer 102 or seller of an item may take advantage of a consumer's 110 discarding of the item 108 to retrieve valued consumer information and survey responses. Before distributing the item 108 to the consumer 110, the manufacturer 102 or another entity may incorporate one or more taggants 104 into a survey response label 106, each taggant associated with a survey response selection, and affix the label to the item 108. The taggants may also be incorporated directly into the item 108. The taggants may be composed of a variety of materials, such as plastic, silicon, polysilicon, metal, fluorescent material, or molecular material and may be manufactured with specific cross sections, shapes or barcodes that may be read. The taggants may be incorporated with optically-readable information, radio frequency (RF)-readable information (RFID tags), and/or chemically-readable information. The information incorporated into the taggants may contain a high number and variation of codes detected upon reading, which may allow the taggants to be read and individually detected in a group, the group including taggants corresponding to all the items in a wash, granulation, or separation batch. The taggants may then be incorporated into one or more portions of the survey response label and/or item by a variety of methods, such as adding, printing, attaching and/or coupling the taggants to the label and/or item.

When the consumer 110 receives the item, instructions may be provided on the taggant incorporated survey response label 106 indicating how the consumer may respond to questions included in the consumer survey. The consumer 110 may remove one or more labels from the survey response label and/or item to indicate a survey response selection. Removal may be performed by a variety of techniques, such as peeling off of a label or removing an ink cover. The label indicating the consumer's survey response selection may be removed. Alternatively, all of the labels except the label corresponding to the consumer's survey response selection may be removed. The instructions provided on the survey response label and/or item may distinguish between the above alternatives. The consumer 110 may then discard the item 108. The item may be composed of a variety of materials, such as polyethylene terephthalate (PET), polyvinyl chloride (PVC), high-density polyethylene (HDPE), or glass. The item may also be composed of one or more metals such as aluminum, steel, gallium, lead, platinum, zinc, nickel, copper, brass, gold, silver, and the like, or combinations thereof.

Upon arrival at a disposal entity 112, such as a recycling facility, a waste management facility, a service facility, and/or a product return facility, the taggants may be separated from the label and/or item. During a pre-wash, a hot-wash, wet granulation, or wet separation the label may dissolve from the item, separating the taggants from the label and/or item. Resulting fluid from the pre-wash, hot wash, wet granulation, or wet separation may be further separated as by straining, vortex flow, or lamellar flow to concentrate the taggants. The concentrated taggants may be machine-read to count a number and codes of taggants. The taggant readings may then be quantified to provide consumer survey responses and the quantified consumer survey responses may be sent to another entity, such as a manufacturer, a seller, and/or a marketing of company. These entities may then use the consumer survey responses to improve manufacturing, selling, and/or advertising strategies for the item 108.

Taking advantage of an item disposal process for gathering consumer survey responses may allow a more efficient and cost effective method of distributing and gathering consumer survey responses by enabling the consumer 110 to give feedback at the same time as discarding the item 108.

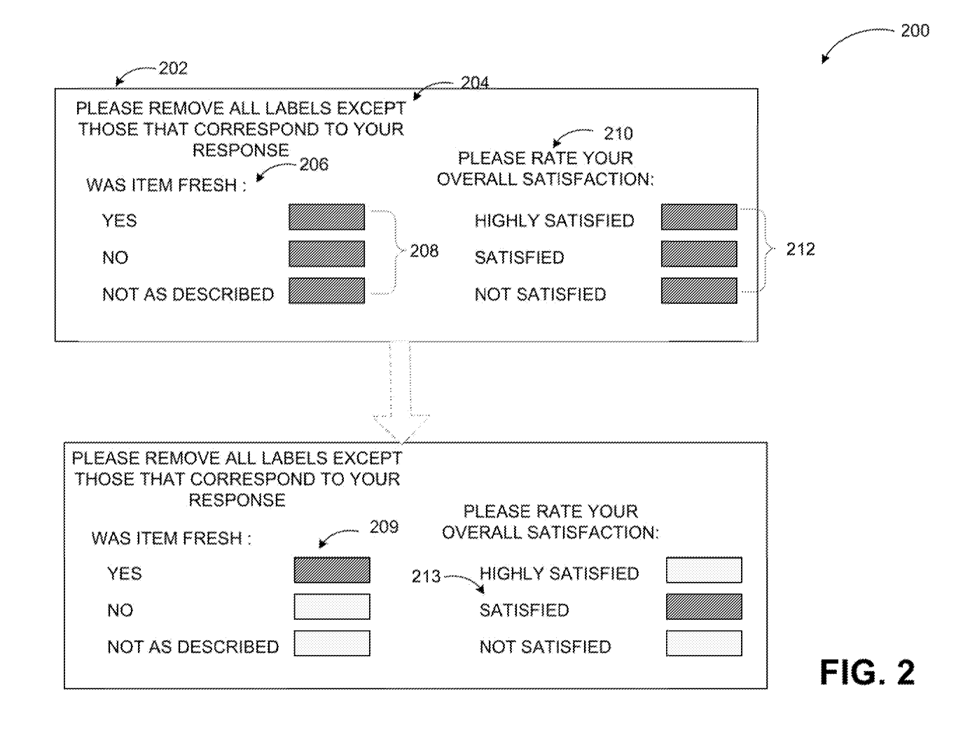

FIG. 2 illustrates an example of survey-directed on-product labeling, where all taggant incorporated labels may be removed by a consumer except for the label indicating a survey response selection, arranged in accordance with at least some embodiments described herein.

As shown in a diagram 200, an item may have a label 202 that includes text 204 to inform the consumer how to indicate their survey response. One or more questions 206 and 210 may be present on the label 202 along with one or more taggant incorporated labels 208 and 212, respectively, to represent survey response selections. In the illustrated example, the text 204 instructs the consumer to “Please remove all labels except ones that correspond to your response” for each of the questions present on the label. In response to the instructions, the consumer may have removed all the taggant incorporated labels except for the label corresponding to their survey response selection, “Yes” 209 the item was fresh and “Satisfied” 213 in regards to overall satisfaction with the item. Removing all the labels except the label indicating the consumer's survey response selection may also remove all the taggants associated with the non-selected survey response selections. As a result, taggants associated with the consumer indicated survey response selection may remain on the product at disposal.

The survey response selections may be provided on multiple taggant incorporated labels or ink covers on the item, where the taggant incorporated labels may be composed of cellulose, wax, gelatin, or scratch-off ink. The removal of the one or more taggant incorporated labels may include peeling of the taggant incorporated label or removal of an ink cover that corresponds to the consumer's survey response selection.

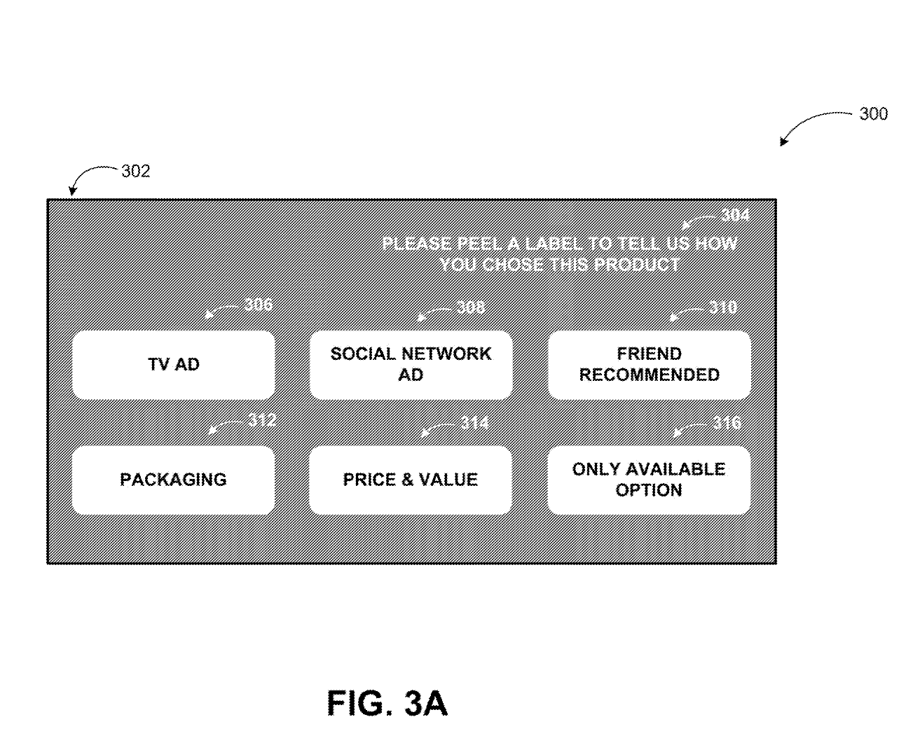

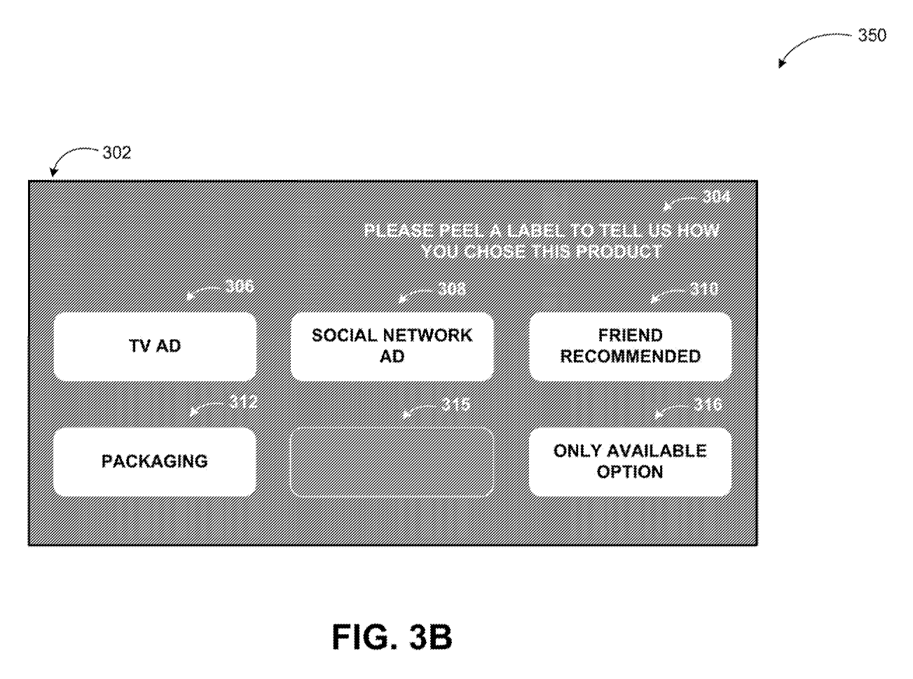

FIGS. 3A and 3B illustrate another example of survey-directed on-product labeling, where a taggant incorporated label on an item may be removed by the consumer to indicate a survey response selection, arranged in accordance with at least some embodiments described herein.

As shown in a diagram 300, the item may have a main label 302 that includes text 304 for informing the consumer how to indicate their survey response. Taggant incorporated labels 306, 308, 310, 312, 314, and 316 may be present on the main label 302 to represent survey response selections. In the illustrated example, the text 304 instructs the consumer to “Peel a label” to provide information on why the consumer chose to purchase the item. Taggant incorporated label 306 corresponds to a survey response “TV Ad”, taggant incorporated label 308 corresponds to a survey response “Social Network Ad”, taggant incorporated label 310 corresponds to a survey response “Friend Recommended”, taggant incorporated label 312 corresponds to a survey response “Packaging”, taggant incorporated label 314 corresponds to a survey response “Price & Value”, and taggant incorporated label 316 corresponds to a survey response “Only Available Option”. Survey responses may be in any order and may be varied in order or placement, such as to remove survey biases due to response order.

As shown in a diagram 350, a taggant incorporated label corresponding to a survey response may be peeled off to indicate a particular survey response. In the illustrated example, the taggant incorporated label corresponding to the survey response “Social Network Ad” has been peeled off 315 to indicate the consumer chose to purchase the item because of a social network ad. Removing the label indicating the consumer's survey response selection may also remove all the taggants associated with the indicated selection. As a result, taggants associated with non-selected survey response selections will remain at disposal.

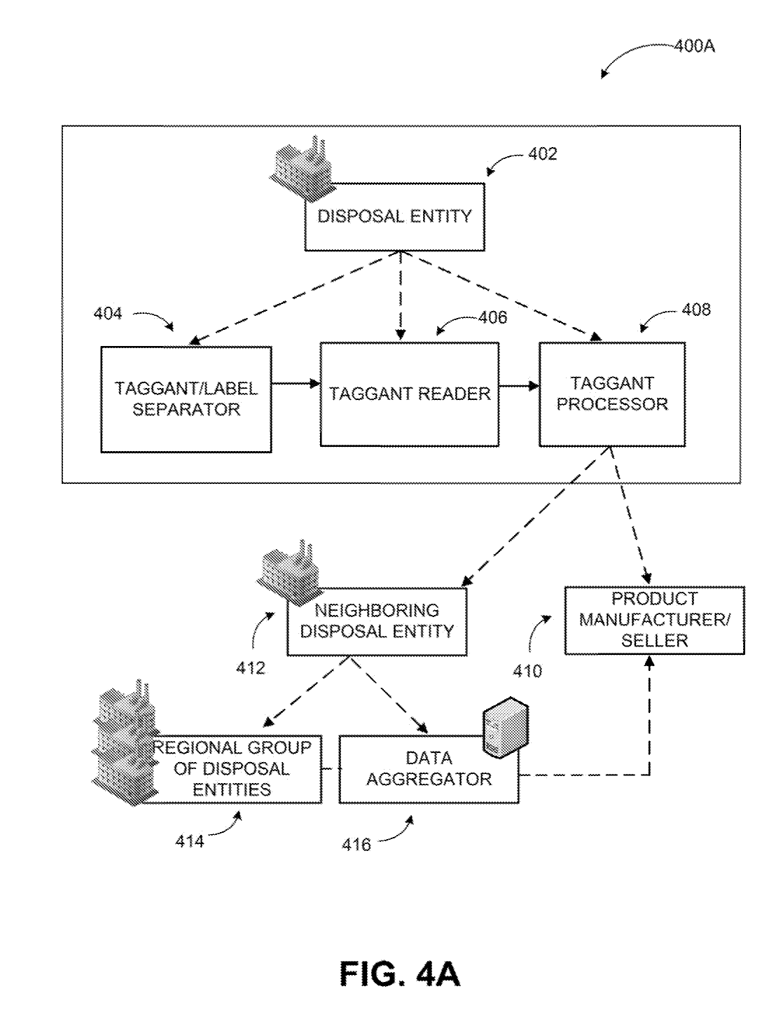

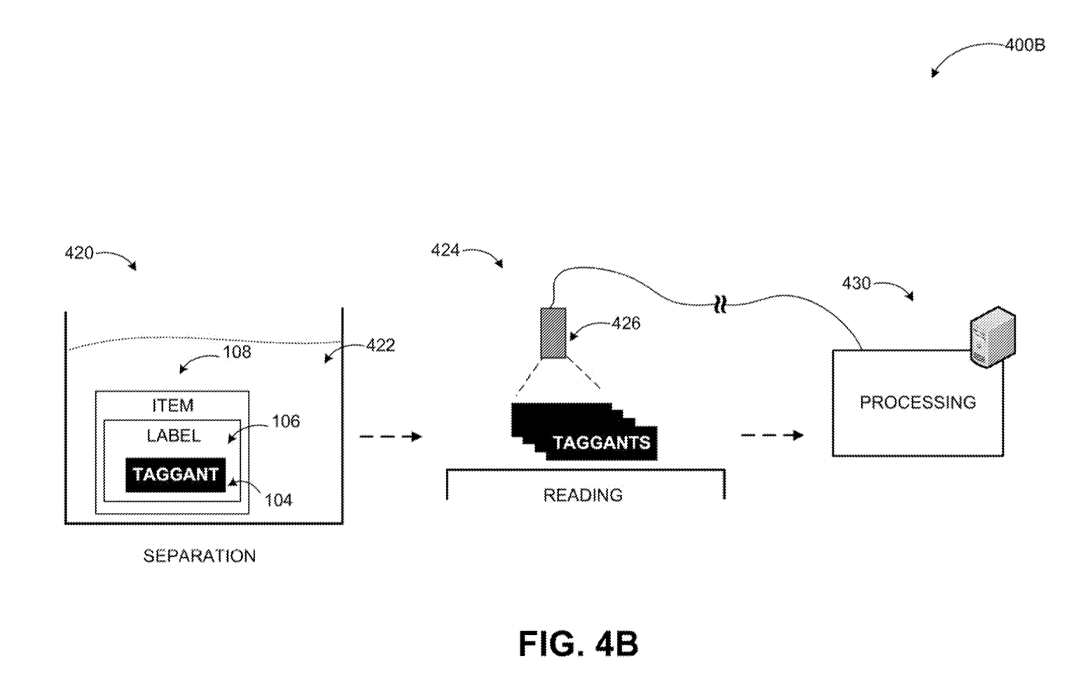

FIG. 4A illustrates an example system, where taggants are separated, read, and processed at disposal to quantify consumer survey responses and provide them to other entities, arranged in accordance with at least some embodiments described herein.

As shown in a diagram 400A, incorporated taggants may be separated from a survey response label affixed to an item by a taggant/label separator 404 at a disposal entity 402. The separated taggants may then be machine-read by a taggant reader 406 to retrieve survey response data from consumers and processed by a taggant processor 408 to quantify the survey response data. The data may then be sent directly to a manufacturer or seller 410 or may be sent to a neighboring disposal entity 412 which may integrate and centralize the data at a regional group of disposal entities 414 or data aggregator 416.

The taggant/label separator 404 may separate taggants from the survey response label by a hot-wash, a pre-wash, wet granulation, or wet separation causing the survey response label to dissolve away from the item. Resulting fluid from the hot-wash, pre-wash, wet granulation, or wet separation may then be further separated as by straining, vortex flow, or lamellar flow to concentrate the taggants. The concentrated taggants may then be read by the taggant reader 406 by optically reading machine-readable code printed on the taggants, scanning radio frequency identification (RFID) tags incorporated into the taggants, or detecting chemical levels incorporated into the taggants. Fast cameras and optical magnifications may be used if optically reading the taggants. Flash-lamps may be used to eliminate blur of motion, and a thermal filter may be used to prevent infrared from the flash-lamps from reflecting and overwhelming the camera.

The taggants may be read in a group to determine code-counts, in which the group of taggants corresponds to all items present in a wash, granulation, or separation batch. The taggant processor 408 may then use the code-counts to indicate granularity of the survey. Incorporating a higher variation and/or number of codes into the taggants before incorporating them into a survey response label and/or item may statistically allow each item in the batch to have unique codes with a resolution at the per-item level. If reusing one code per survey response enough that multiple items with the same survey response may be expected in each batch, then statistical distributions and the number of taggants detected may be used to estimate the number of consumers who chose each survey response in each batch. Raising the number and/or variation of code-counts determined to detect individual survey responses may further allow additional code variation within the taggants to indicate more granular purchase data, such as a location of sale, a date of sale, a particular distributor, a promotion, additional questions, or packaging types. If a label indicating survey response selection was removed by a consumer, the taggant processor 408 may further quantify the retrieved survey response data by detecting taggants associated with non-selected labels. If all labels are removed by a consumer except for a label indicating survey response selection, the taggant processor 408 may further quantify the retrieved survey response data by detecting taggants associated with the selected label.

Furthermore, the disposal entity may regularly perform a calibration test per taggant type, to determine the expected collectible percentage per taggant per item per time period. An example of such a calibration test may include regularly selecting a few taggant codes to be test tags and including a test item, with a known quantity of the test tags, into a wash, granulation, or separation batch. Using the above test, a minimal wash fluid sample to measure may be determined. For example, to obtain X taggants per response may involve collection of Y % of the fluid sample to measure. Based on the minimal wash fluid sample to measure, an estimation may be performed. For a particular disposal entity the estimation may conclude that for a number of taggants of a certain type counted, a certain number of items with those taggants incorporated were processed. Alternatively, a similar calibration test may be performed at the batch level to determine an estimation for the expected collectible percentage per taggant per item per time period. For example, for a particular disposal entity, in a batch of 100 items, 20 selections of a particular survey response may be counted, where 15,000 tags of a particular type may have been read. In either calibration method, each disposal entity may preferably be calibrated to account for a particular difference in processes to provide closer statistically significant answers.

FIG. 4B further illustrates an example system, where taggants may be separated, read, and processed at disposal, arranged in accordance with at least some embodiments described herein.

As shown in a diagram 400B, at disposal a separation module 420 may separate the taggant 104 from a survey response label 106 affixed to an item 108 by causing the label 106 to dissolve via a hot-wash 422. Resulting fluid from the hot-wash may be further separated by straining, settling, vortex flow, or lamellar flow to concentrate the taggants. A taggant reading module 424 may then read the taggants in a group to determine code-counts, in which the group of taggants corresponds to all items present in the wash batch. The taggant reader 426 may read the taggants by optically reading machine-readable code printed on the taggants, scanning radio frequency identification (RFID) tags incorporated into the taggants, or detecting chemical levels incorporated into the taggants. A taggant processing module 430 may then quantify consumer response data based on the taggant readers. Responses may be quantified by detecting taggants associated with non-selected labels, if a label indicating survey response selection was removed by a consumer. Or, responses may be quantified by detecting taggants associated with the selected label, if all labels were removed by a consumer except for a label indicating survey response selection.

FIGS. 1 through 4B have been described using specific examples and processes in which gathering survey response data from consumers may be implemented by recovering taggants at disposal. Embodiments for gathering survey response data from consumers by recovering taggants at disposal are not limited to the examples and processes according to these figures.

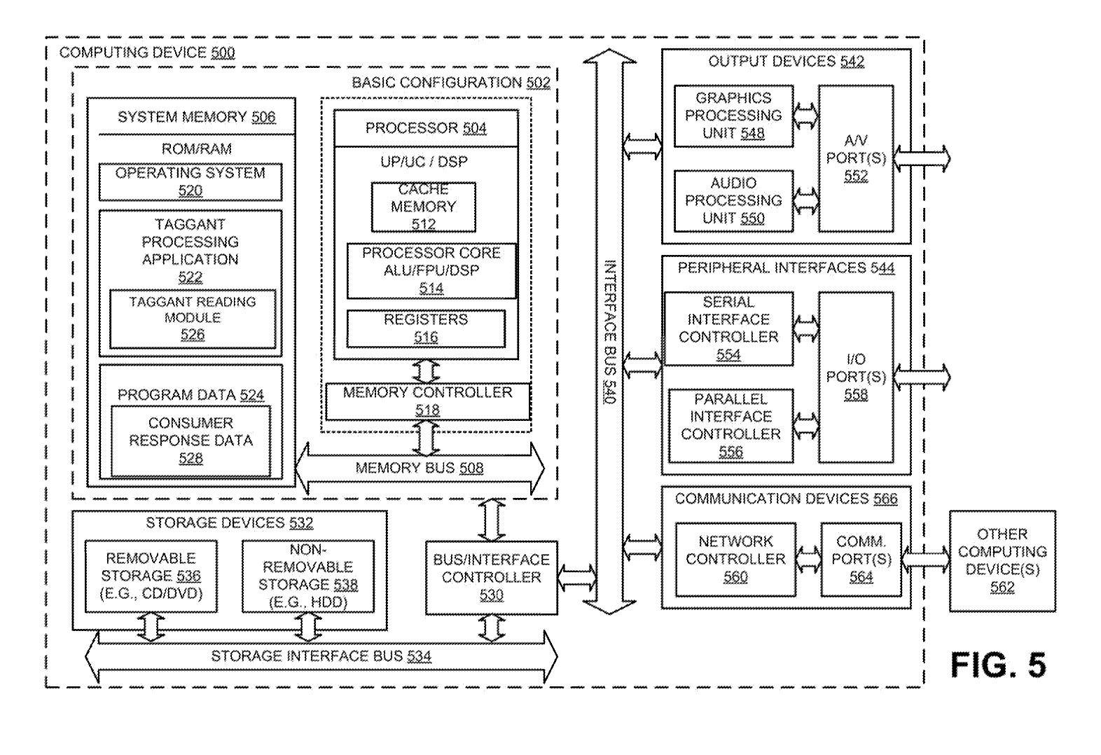

FIG. 5 illustrates a general purpose computing device, which may gather survey response data from consumers based on recoverable taggants at disposal, arranged in accordance with at least some embodiments described herein.

For example, the computing device 500 may be used to read and process survey response data from consumers based on recoverable taggants at disposal as described herein. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, a processor core 514, and registers 516. The example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a taggant processing application 522, and program data 524. The taggant processing application 522 may include a taggant reading module 526 to machine-read taggants to quantify consumer survey responses as described herein. The program data 524 may include, among other data, consumer response data 528 or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 566) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 566 includes a network controller 560, which may be arranged to facilitate communications with one or more other computing devices 562 over a network communication link via one or more communication ports 564. The one or more other computing devices 562 may include servers at a manufacturer, survey entity, advertiser, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods for gathering survey response data from consumers based on recoverable taggants at disposal. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

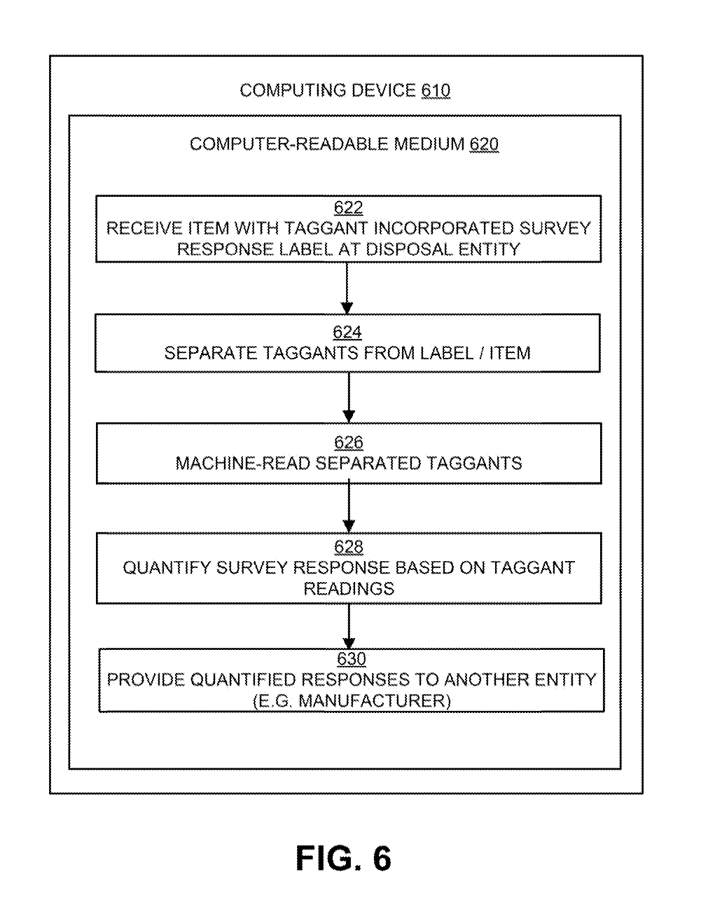

FIG. 6 is a flow diagram illustrating an example method for gathering survey response data from consumers based on recoverable taggants at disposal that may be performed by a computing device such as the computing device in FIG. 5, arranged in accordance with at least some embodiments described herein.

Example methods may include one or more operations, functions or actions as illustrated by one or more of blocks 622, 624, 626, 628 and/or 630, and may in some embodiments be performed by a computing device such as the computing device 500 in FIG. 5. The operations described in the blocks 622-630 may also be stored as computer-executable instructions in a computer-readable medium such as a computer-readable medium 620 of a computing device 610.

An example process for gathering survey response data from consumers based on recoverable taggants at disposal may begin with block 622, “RECEIVE ITEM WITH TAGGANT INCORPORATED SURVEY RESPONSE LABEL AT DISPOSAL ENTITY”, where a consumer 110, prior to disposal, may have removed one or more taggant incorporated labels from a survey response label 106 or item 108 to indicate a survey response selection. The taggants 104 may have been incorporated into the survey response label 106 or item 108 by a manufacturer 102 prior to the consumer's purchase of the item, with each taggant associated with a survey response selection.

Block 622 may be followed by block 624, “SEPARATE TAGGANTS FROM LABEL/ITEM”, where a pre-wash, a hot-wash, wet granulation, or wet separation may dissolve a taggant-incorporated label separating taggants 104 from the label 106 or item 108. Resulting fluid from the pre-wash, a hot-wash, wet granulation, or wet separation may be further separated by straining, vortex flow, or lamellar flow to concentrate the separated taggants.

Block 624 may be followed by block 626, “MACHINE-READ SEPARATED TAGGANTS”, where the separated taggants may be read in a group to determine a code-count, the group of taggants corresponding to all items present in a wash, granulation, or separation batch, by optically reading machine-readable code printed on the taggants, scanning radio frequency identification (RFID) tags incorporated into the taggants, or detecting chemical levels incorporated into the taggants.

Block 626 may be followed by block 628, “QUANTIFY SURVEY RESPONSE BASED ON TAGGANT READINGS”, where code-counts determined from taggant readings may allow a taggant processing module 430 to determine granularity of survey. The code-count of taggants may detect individual survey responses and further allow additional code variation within the taggants to indicate more granular purchase data, for example, a location of product sale, a date of product sale, or a distributor of product. The taggant processing module 430 may quantify the retrieved survey response data by detecting taggants associated with non-selected labels, if a label indicating survey response selection was removed by a consumer. Or, the taggant processing module 430 may quantify the retrieved survey response data by detecting taggants associated with the selected label, if all labels were removed by a consumer except for a label indicating survey response selection.

Block 628 may be followed by block 630, “PROVIDE QUANTIFIED RESPONSES TO ANOTHER ENTITY (FOR EXAMPLE MANUFACTURER)”, where the quantified responses may be sent to an entity, such as manufacturer, a seller, or a marketing company. The responses, containing consumer feedback, may be useful in determining new marketing, packaging, or distribution strategies to increase product sales and consumer satisfaction.

The operations included in the process of FIG. 6 described above are for illustration purposes. Gathering survey response data from consumers by recovering taggants at disposal may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at substantially the same time.

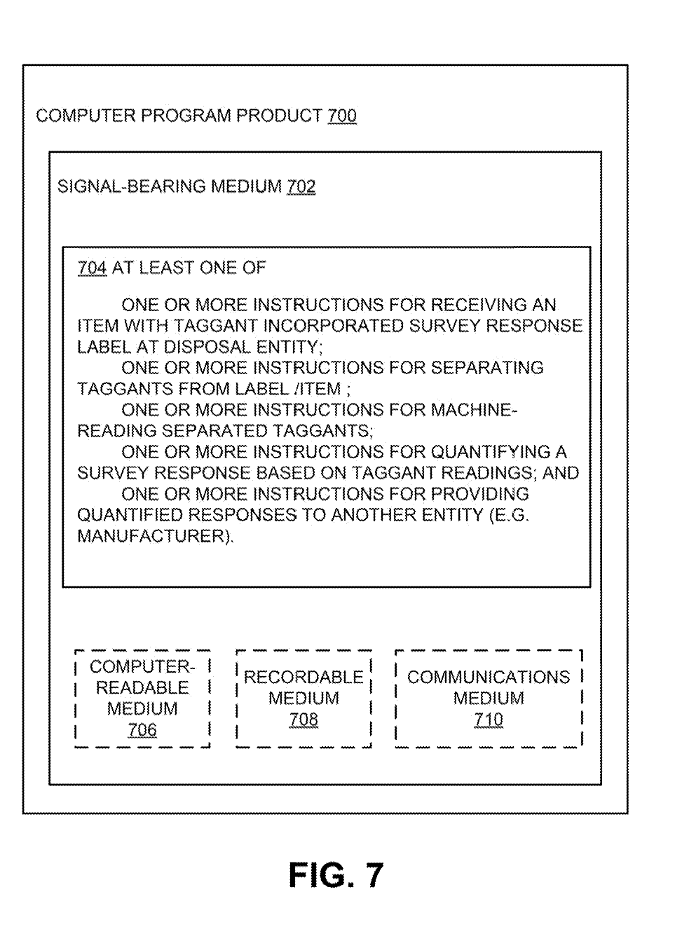

FIG. 7 illustrates a block diagram of an example computer program product, arranged in accordance with at least some embodiments described herein.

In some examples, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, the taggant processing application 522 or the taggant reading module 526 may undertake one or more of the tasks shown in FIG. 7 in response to the instructions 704 conveyed to the processor 504 by the medium 702 to perform actions associated with gathering survey response data from consumers by recovering taggants at disposal as described herein. Some of those instructions may include, for example, receiving an item with taggant incorporated survey response label at disposal entity, separating taggants from label/item, machine-reading separated taggants, quantifying a survey response based on taggant readings, and providing quantified responses to another entity (for example manufacturer), according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (for example, a fiber optic cable, a waveguide, a wired communications link, a wireless communication link, etc.). Thus, for example, the program product 700 may be conveyed to one or more modules of the processor 704 by an RF signal bearing medium, where the signal bearing medium 702 is conveyed by the wireless communications medium 710 (for example, a wireless communications medium conforming with the IEEE 802.11 standard).

According to some examples, a method is provided for survey response collection from consumers based on recoverable taggants at disposal. The method may include providing a taggant incorporated survey response label attached to an item. The method may also include providing instructions to consumers to indicate a survey response by removing one or more labels from the item such that survey response data is collected through remaining taggants on the item at disposal.

According to other examples, the taggants may be composed of one or more of plastic, silicon, polysilicon, metal, fluorescent material, and molecular material. One or more of optically-readable information, radio frequency (RF)-readable information, and chemically-readable information may be incorporated into the taggants. Incorporating the taggants into the survey response label may include adding, printing, attaching or coupling the taggants to the survey response label. The taggants may be incorporated into one or more portions of the item by adding, printing, attaching, or coupling.

According to further examples, available survey response selections may be provided on a plurality of labels or ink covers on the item. The one or more taggant incorporated labels may be composed of cellulose, wax, gelatin, or scratch-off ink. Removal of the one or more taggant incorporated labels may be allowed by peeling of a label or removing an ink cover to indicate survey a response selection, where the survey response selection is indicated by removal of a label or by removal of all labels except one. The one or more taggant incorporated labels may be dissolvable in water or one or more solvents. The item may be composed of various materials such as polyethylene terephthalate (PET), polyvinyl chloride (PVC), high-density polyethylene (HDPE), or glass. The item may also be composed of aluminum, steel, gallium, lead, platinum, zinc, nickel, copper, brass, gold, silver or combinations thereof.

According to some embodiments, a method is provided for gathering survey response data from consumers by recovering taggants at disposal. The method may include receiving an item with one or more taggant incorporated survey response labels at a disposal entity and separating taggants from the item. The method may also include retrieving survey response data from the separated taggants through a machine-readable process and quantifying the retrieved survey response data.

According to other embodiments, separating the taggants from the item may include one or more of a pre-wash, a hot-wash, a wet granulation, settling, or a wet separation. The survey response labels may be dissolved during the separation of the taggants from the item. A resulting fluid may be separated by one of straining, vortex flow, or lamellar flow to concentrate the taggants. The taggants may be machine-read in a group to determine a code-count of the taggants and the code-count may be used to determine a granularity of the survey. Raising the code-count of the taggants may detect individual survey responses and further allow additional code variation within the taggants to indicate more granular purchase data, where the granular purchase data may include a location of sale, a date of sale, a particular distributor, a promotion, additional questions, or packaging types.

According to further embodiments, retrieving the survey response data from the separated taggants may include one or more of optically reading machine-readable code printed on the taggants, scanning radio frequency identification (RFID) tags incorporated into the taggants, or detecting chemical levels incorporated into the taggants. The taggants may be optically read using fast cameras and optical magnification heads with flash-lamps to eliminate the blur of motion and a thermal filter may be used to prevent infrared from the flash-lamp from reflecting and overwhelming the camera. Quantifying the retrieved survey response data may comprise detecting taggants associated with non-selected labels, if a label indicating survey response selection was removed by a consumer. Quantifying the retrieved survey response data may comprise detecting taggants associated with the selected label, if all labels were removed by a consumer except for a label indicating survey response selection. The quantified survey response data may be provided to a manufacturer, a seller, a marketing company, or a disposal entity. Quantified survey responses from one or more disposal entities may be integrated and centralized at a regional group of disposal entities or a centralized data aggregator.

According to some examples, a system is described for gathering survey response data from consumers by recovering taggants at disposal. The system may include at least one separation module configured to separate taggants from an item with one or more taggant incorporated survey response labels. The system may also include at least one taggant reading module configured to retrieve survey response data from the separated taggants through a machine-readable process and at least one taggant processing module configured to quantify the retrieved survey response data. The system may further include at least one controller configured to coordinate operations of the separation module, the taggant reading module, and the taggant processing module.

According to other examples, the separation module may be configured to separate the taggants through one or more of a pre-wash, a hot-wash, a wet granulation, or a wet separation, where the separation module may be further configured to cause the survey response labels to be dissolved during the separation of the taggants from the item. The separation module may be further configured to separate a resulting fluid by one of straining, vortex flow, or lamellar flow to concentrate the taggants. The taggant reading module may be configured to machine-read the taggants in a group to determine a code-count of the taggants, where the taggant processing module may be configured to use the code-count to determine a granularity of the survey. The taggant processing module may be configured to raise the code-count of the taggants to detect individual survey responses and further allow additional code variation within the taggants to indicate more granular purchase data, where the granular purchase data may include a location of sale, a date of sale, a particular distributor, a promotion, additional questions, or packaging types.

According to further examples, the taggant reading module may be configured to retrieve the survey response data from the separated taggants through one or more techniques such as of optically reading machine-readable code printed on the taggants, scanning radio frequency identification (RFID) tags incorporated into the taggants, or detecting chemical levels incorporated into the taggants. The taggant reading module may be configured to optically read the machine-readable code printed on the taggants using fast cameras and optical magnification heads with flash-lamps to eliminate the blur of motion, where a thermal filter may be used to prevent infrared from the flash-lamp from reflecting and overwhelming the camera. The taggant processing module may be configured to quantify the retrieved survey response data by detecting taggants associated with non-selected labels, if a label indicating survey response selection was removed by a consumer. The taggant processing module may be configured to quantify the retrieved survey response data by detecting taggants associated with the selected label, if all labels were removed by a consumer except for a label indicating survey response selection. The controller may be further configured to provide the quantified survey response data to a manufacturer, a seller, a marketing company, or a disposal entity, where the controller may be further configured to integrate and centralize quantified survey responses from one or more disposal entities at a regional group of disposal entities or a centralized data aggregator.

According to some embodiments, a taggant-based survey response collection system is described. The system may include one or more survey response labels attached to an item, the labels configured to provide instructions to consumers to indicate a survey response by removing one or more of the labels from the item. The system may also include one or more taggants incorporated into the labels such that survey response data is collected at disposal through taggants remaining on the item after removal of the one or more labels.

According to other embodiments, the taggants may be composed of one or more of materials such as plastic, silicon, polysilicon, metal, fluorescent material, or molecular material. The taggants may include one or more of optically-readable information, radio frequency (RF)-readable information, and chemically-readable information. The taggants may be incorporated into the survey response label through one of adding, printing, attaching, or coupling and the taggants may be incorporated into one or more portions of the item through one of adding, printing, attaching, or coupling. Available survey response selections may be provided on a plurality of labels or ink covers on the item and the one or more taggant incorporated labels may be composed of cellulose, wax, gelatin, or scratch-off ink.

According to further embodiments, the one or more taggant incorporated labels may be removable through peeling of a label or removing an ink cover to indicate survey a response selection, where the survey response selection may be indicated by removal of a label or by removal of all labels except one. The survey response labels may be dissolvable through one or more of a pre-wash, a hot-wash, a wet granulation, or a wet separation. The item may be composed of polyethylene terephthalate (PET), polyvinyl chloride (PVC), high-density polyethylene (HDPE), or glass. The item may also be composed of aluminum, steel, gallium, lead, platinum, zinc, nickel, copper, brass, gold, silver, or combinations thereof.

### EXAMPLES

Following are illustrative examples of how some embodiments may be implemented, and are not intended to limit the scope of embodiments in any way.

### Example 1

### An Athlete Disposing of a Plastic Milk Container with an On-Product, Taggant Incorporated Peel-Off Survey Label

An athlete, upon finishing a container of milk, may notice a wax survey response label on the milk container. Unbeknownst to the athlete, taggants may have been incorporated into the label, where the taggants may be associated with survey response selections. The survey response may provide instructions to “Please remove the label that indicates how fresh the item was.” Survey response selection may include, “Very Fresh”, “Fresh”, “Somewhat Fresh”, “Not Fresh”, and “Spoiled”. The athlete may peel off the label “Somewhat Fresh” to indicate the freshness of the item. Peeling off the label may also remove all the incorporated taggants associated with “Somewhat Fresh”. The milk container, composed of high-density polyethylene, may then be disposed of via recycling.

Upon arrival at the recycling center, the label may dissolve away from the milk container during wet granulation causing the remaining taggants to be separated from the label and the item. After wet granulation, taggants may be further separated from resulting fluid by straining to concentrate the taggants. The taggants may then be read in a group, the group of taggants corresponding to all items present in the wet granulation batch, to determine a code-count of the taggants using a fast camera and optical head magnification. Flash-lamps may be used to eliminate the blur of motion and a thermal filter may be used to prevent infrared from the flash-lamp from reflecting and overwhelming the camera. The code-count of the taggants may associate with the multiple non-selected survey responses, “Very Fresh”, “Fresh”, “Not Fresh”, and “Spoiled”. As a result, the individual survey response of the athlete may be quantified as “Somewhat Fresh”, representing the missing response. The code-count may also reveal that the athlete had purchased a gallon sized milk container from a distributor in the state of Florida, USA. The quantified data may then be sent to a seller and the seller may use the data to increase customer satisfaction by ensuring milk jugs are fresh when purchased in the store.

### Example 2

### A Teenager Disposing of a Metal Soda Can with an On-Product, Taggant Incorporated Scratch-Off Survey Label

A teenager, upon finishing a can of a new brand of soda, may notice a scratch off ink survey response label on the can. Unbeknownst to the teenager, taggants may have been incorporated into the label, where the taggants may be associated with survey response selections. The survey response may provide instructions to “Please remove all labels except the label that indicates how you heard about the new brand of soda.” Survey response selection may include, “Television Advertisement”, “Radio Advertisement”, “Social Media”, “Print Advertisement”, and “Friend Recommended”. The teenager may scratch off all the labels except for “Television Advertisement” to indicate he had heard about the new brand of soda in a television advertisement. Scratching off all the labels except for “Television advertisement” may also remove all the incorporated taggants associated with non-selected responses “Radio Advertisement”, “Social Media”, “Print Advertisement”, and “Friend Recommended”. The soda can, composed of aluminum, may then be disposed of.

Upon arrival at a waste management facility, the label may dissolve away from the soda can during a hot-wash causing the remaining taggant to be separated from the label and the item. After the hot wash, taggants may be further separated from resulting fluid by vortex flow to concentrate the taggants. The taggants may then be read in a group corresponding to the items in the hot-wash batch to determine a code-count of the taggants by scanning radio frequency identification (RFID) tags incorporated into the taggants. The code-count of the taggants may associate with the selected survey response, “Television Advertisement”. As a result, the individual survey response of the teenager may be quantified as “Television Advertisement”. The code-count may also reveal that the teenager had purchased the can from a supermarket on Sep. 1, 2012. The quantified data may then be sent to a marketing company and the marketing company may use the data to improve marketing strategies to improve sales of the new brand of soda.

### Example 3

### A Businessman Disposing of a Glass-Bottled Iced Coffee with an On-Product, Taggant Incorporated Peel-Off Survey Label

A businessman, upon finishing a bottle of iced coffee, may notice a peel off survey response label on the bottle. Unbeknownst to the businessman, taggants may have been incorporated into the label, where the taggants may be associated with survey response selections. The survey response may provide instructions to “Please remove the label that indicates if you would purchase the item again.” Survey response selection may include, “Yes”, and “No”. The businessman may peel off the label “No” to indicate that he will not purchase the iced coffee again. Peeling off the label may also remove all the incorporated taggants associated with “Yes”, causing the remaining taggants to be associated with the businessman's survey response selection of “No.” The iced coffee bottle, composed of glass, may then be disposed of.

Upon arrival at a disposal facility, the label may dissolve away from the glass bottle during a pre-wash causing the remaining taggants to be separated from the label and the item. After the pre-wash, taggants may be further separated from resulting fluid by lamellar flow to concentrate the taggants. The taggants may then be read in a group, the group of taggants corresponding to all items present in the pre-wash batch, to determine a code-count of the taggants by detecting chemical levels incorporated into the taggants. The code-count of the taggants may associate with the businessman's selected survey responses, “No”. As a result, the individual survey response of the businessman may be quantified as “No”. The code-count may also reveal that the businessman had purchased the iced coffee from a local corner store that was holding a 2-for-1 promotion on the iced coffee. The quantified data may then be sent to a manufacturer to determine customer satisfaction.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example, as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors for moving and/or adjusting components and/or quantities).

A typical data processing system may be implemented utilizing any suitable commercially available components, such as those typically found in taggant reading and quantification systems used to gather data. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for survey response collection from consumers based on recoverable taggants at disposal, the method comprising;
providing one or more survey response labels attached to an item, wherein each of the one or more survey response labels are incorporated with at least one taggant; and
providing instructions to consumers on the item to indicate a survey response by removing at least one of the one or more survey response labels from the item such that survey response data is determined based on remaining taggants on the item when the item is disposed.

2. The method of claim 1, further comprising composing the taggants of one or more of plastic, silicon, polysilicon, metal, fluorescent material, and molecular material.

3. The method of claim 1, further comprising incorporating into the taggants one or more of optically-readable information, radio frequency readable (RF-readable) information, and chemically-readable information.

4. The method of claim 1, wherein the taggants are incorporated into the one or more survey response labels through adding, printing, attaching or coupling the taggants to the one or more survey response labels.

5. The method of claim 1, further comprising incorporating the taggants into one or more portions of the item by adding, printing, attaching, or coupling.

6. The method of claim 1, further comprising providing available survey response selections on a plurality of labels or ink covers on the item.

7. The method of claim 1, wherein the one or more survey response labels are composed of cellulose, wax, gelatin, or scratch-off ink.

8. The method of claim 1, wherein removal of the one or more survey response labels is allowed by peeling of a label or removing an ink cover to indicate survey a response selection.

9. The method of claim 8, wherein the survey response selection is indicated by removal of a label.

10. The method of claim 8, wherein the survey response selection is indicated by removal of all labels except one.

11.-13. (canceled)

14. A method to gather survey response data from consumers by recovering taggants at disposal, the method comprising;
receiving an item with one or more survey response labels attached at a disposal entity, wherein each of the one or more survey response labels are incorporated with at least one taggant;
separating taggants from the item;
retrieving survey response data from the separated taggants through a machine-readable process; and
quantifying the retrieved survey response data.

15.-17. (canceled)

18. The method of claim 14, further comprising machine-reading the taggants in a group to determine a code-count of the taggants, wherein the code-count is used to determine a granularity of the survey.

19. (canceled)

20. The method of claim 18, further comprising raising the code-count of the taggants to detect individual survey responses and further allow additional code variation within the taggants to indicate more granular purchase data, wherein the granular purchase data includes a location of sale, a date of sale, a particular distributor, a promotion, additional questions, or packaging types.

21.-26. (canceled)

27. The method of claim 14, further comprising providing the quantified survey response data to a manufacturer, a seller, a marketing company, or a disposal entity.

28. The method of claim 27, further comprising, integrating and centralizing quantified survey responses from one or more disposal entities at a regional group of disposal entities or a centralized data aggregator.

29. A system to gather survey response data from consumers by recovering taggants at disposal, the system comprising;
at least one separation module configured to separate taggants from an item with one or more survey response labels, wherein each of the one or more survey response labels are incorporated with at least one taggant;
at least one taggant reading module configured to retrieve survey response data from the separated taggants through a machine-readable process;
at least one taggant processing module configured to quantify the retrieved survey response data; and
at least one controller configured to coordinate operations of the separation module, the taggant reading module, and the taggant processing module.

30. The system of claim 29, wherein the separation module is configured to separate the taggants through one or more of a pre-wash, a hot-wash, a wet granulation, or a wet separation.

31. The system of claim 30, wherein the separation module is thriller configured to cause the one or more survey response labels to be dissolved during the separation of the taggants from the item.

32. The system of claim 30, wherein the separation module is further configured to separate a resulting fluid by one of straining, vortex flow, or lamellar flow to concentrate the taggants.

33.-36. (canceled)

37. The system of claim 29, wherein the taggant reading module is configured to retrieve the survey response data from the separated taggants through one or more of optically reading, machine-readable code printed on the taggants, scanning radio frequency identification (RFID) tags incorporated into the taggants, or detecting chemical levels incorporated into the taggants.

38. The system of claim 37, wherein the taggant reading module is configured to optically read the machine-readable code printed on the taggants using fast cameras and optical magnification heads with flash-lamps to eliminate the blur of motion, wherein a thermal filter is used to prevent infrared from the flash-lamp from reflecting and overwhelming the camera.

39. (canceled)

40. The system of claim 29, wherein the taggant processing module is configured to quantify the retrieved survey response data by detecting taggants associated with non selected survey response labels, if a survey response label that indicates survey response selection was removed by a consumer.

41. The system of claim 29, wherein the taggant processing module is configured to quantify the retrieved survey response data by detecting taggants associated with a selected survey response label, if all survey response labels were removed by a consumer except for the selected survey response label that indicates survey response selection.

42.-55. (canceled)

55. The system of claim 29, wherein the item is composed of polyethylene terephthalate (PET), polyvinyl chloride (PVC), high-density polyethylene (HDPE), or glass.

56. The system of claim 29, wherein the item is composed of aluminum, steel, gallium, lead, platinum, zinc, nickel, copper, brass, gold, silver, or combinations thereof.
